(19) United States
(12) Patent Application Publication
(10) Pub. No.: US 2014/0252858 A1
(43) Pub. Date: Sep. 11, 2014

(54) Automated Network Power Cycling Device

(71) Applicant: Charles Blake Caudill, Canonsburg, PA (US)

(72) Inventor: Charles Blake Caudill, Canonsburg, PA (US)

(21) Appl. No.: 14/188,777

(22) Filed: Feb. 25, 2014

Related U.S. Application Data
(60) Provisional application No. 61/772,802, filed on Mar. 5, 2013.

(51) Int. Cl. H02J 3/00

(52) U.S. Cl. CPC H02J 3/00
USPC 307/41

(57) ABSTRACT

An automated power cycling device according to one example embodiment includes a base, a first plug connected to the base and for receiving a first network equipment device, a second plug connected to the base and for receiving a second network equipment device and an adapter connected to the base and for plugging into an input voltage source. The automated power cycling device is configured to initiate power transmission to the first network equipment device and the second network equipment device in sequential order.

### CROSS-REFERENCE TO RELATED APPLICATIONS

This application claims priority to U.S. Provisional Application No. 61/772,802, entitled “Automated Network Power Cycling Device” and filed on Mar. 5, 2013, which is incorporated by reference herein in its entirety.

### BACKGROUND

1. Field of the Disclosure

The present invention relates to systems and methods for network power cycling.

2. Description of the Related Art

Power cycling is an important part of connectivity maintenance for many networks, including small networks. When a small network loses connectivity, the solution is often to power cycle the network equipment in sequential order. However, power cycling the network equipment when a network loses connectivity usually results in the loss of network connectivity at an inconvenient time when a user is trying to use the network.

Further, power cycling includes turning the network equipment off and then turning the equipment on again. Thus, power cycling typically requires physical removal and replacement of a cord supplying voltage to the network equipment from the source of power such as, but not limited to, a wall receptacle. Some equipment also has a back-up battery that must be removed and replaced for a complete power cycle to occur. Such removal and replacement of a cord and battery are inefficient and time consuming.

Currently, there are various devices for automatically power cycling electronic equipment. However, such devices are not directed at power cycling network equipment in sequential order. The sequential order mentioned is important for proper connectivity.

That is, there are two separate network devices that usually form a network, the modem and the router. The modem is often provided by an Internet Service Provider (ISP). The modem establishes a connection to the ISP through a phone line, coaxial cable or fiber, for example. The modem is responsible for converting analog signals to digital signals and important to the connection to the Internet. Locations including homes, buildings and businesses are physical locations that often have network access to the Internet. The router routes network traffic properly in individual networks. The router allows multiple computers or pieces of equipment to connect to the Internet. The router gives equipment, such as computers, phones or tablets, a specific address to connect to the network. That address is important for the connection to occur. Some routers also provide wireless connectivity. The modem is typically connected to the router by an Ethernet cable. This cable connects the router to the Internet.

To perform an effective power cycle of the modem and router, a sequential order should be followed. The modem should have an established connection to the ISP before the router connects to the modem. The router will not communicate on the Internet if the modem is not communicating to the ISP to get to the Internet. When the modem and router are powered off and on at the same time, the modem is still establishing a connection to the ISP while the router is trying to talk on the Internet. It can often take up to 60 seconds for the modem to communicate to the ISP to establish a connection.

Current devices fail to meet the needs of the industry because they do not power up network equipment sequentially. Rather, current dual automatic timers power up two devices at the same time. Delayed power up for the network equipment, such as the modem and router, assists in allowing the network to connect properly. Accordingly, it will be appreciated that systems and methods that automatically power cycle network equipment in a sequential order are desired.

### SUMMARY

An automated power cycling device according to one example embodiment includes a base, a first plug connected to the base and for receiving a first network equipment device, a second plug connected to the base and for receiving a second network equipment device and an adapter connected to the base and for plugging into an input voltage source. The automated power cycling device is configured to initiate power transmission to the first network equipment device and the second network equipment device in sequential order.

An automated power cycling device according to another example embodiment includes a base, a first plug connected to the base and for receiving a first network equipment device, a second plug connected to the base and for receiving a second network equipment device and an adapter connected to the base and for plugging into an input voltage source. The automated power cycling device automatically shuts off power to the first and second network equipment devices and then restores power to the first network equipment device and the second network equipment device in sequential order.

A power strip device according to one example embodiment includes an automated power cycling device having a base, a first plug connected to the base and a second plug connected to the base and a power cord. The first plug is for receiving a first network equipment device, the second plug is for receiving a second network equipment device and the power cord is for plugging into an input voltage source. The automated power cycling device is configured to initiate power transmission to the first network equipment device and the second network equipment device in sequential order.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a front elevation view of an automated power cycling device according to one example embodiment;

FIG. 2 is a rear elevation view of the automated power cycling device illustrated in FIG. 1;

FIG. 3 is a side elevation view of the automated power cycling device illustrated in FIG. 1;

FIG. 4 is a top plan view of the automated power cycling device illustrated in FIG. 1;

FIG. 5 is a front elevation view of the automated power cycling device according to another example embodiment;

FIG. 6 is a side elevation view of the automated power cycling device illustrated in FIG. 5;

FIG. 7 is a front elevation view of a power strip with the automated power cycling device according to one example embodiment;

FIG. 8 is a front elevation view of a power strip with the automated power cycling device according to another example embodiment;

FIG. 9 is a front elevation view of a power strip with the automated power cycling device according to another example embodiment; and

FIG. 10 is a front elevation view of a power strip with the automated power cycling device according to another example embodiment.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, process and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense and the scope of the invention is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings and mountings. In addition, the terms “connected” and “coupled” and variations thereof are not restricted to physical or mechanical connections or couplings.

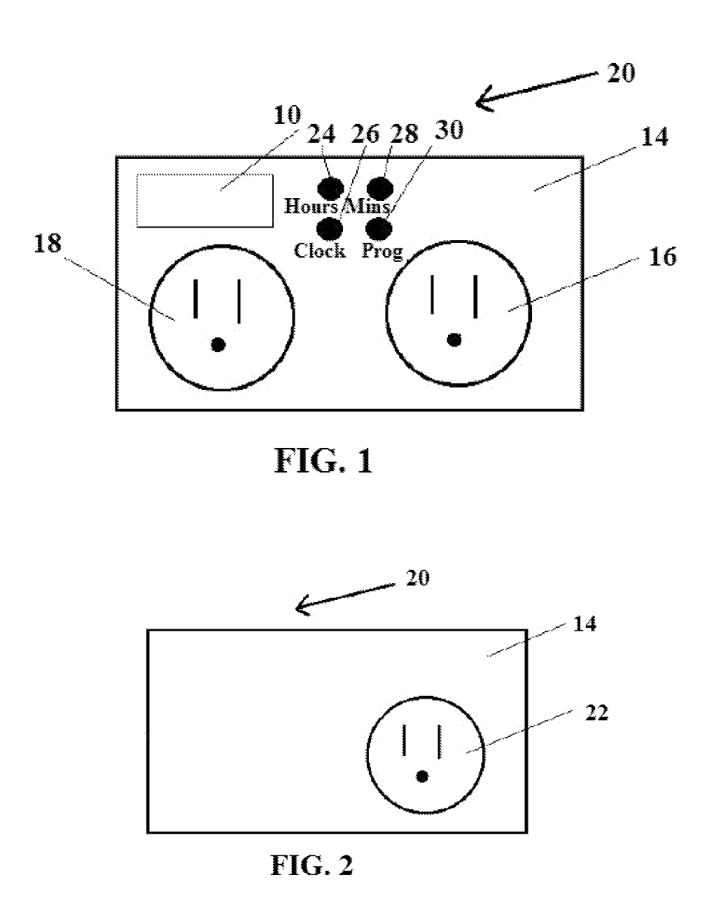

Turning now to the drawings, and more particularly to FIGS. 1 and 2, an example embodiment of an automated power cycling device 20 is illustrated. The device 20 may automatically power cycle network equipment, such as a modem and router, for example, in a sequential order. In multiple embodiments, the device 20 includes a base 14, a first plug 18, a second plug 16 and a male adapter 22.

Referring to FIG. 1, the base 14 of the automated power cycling device 20 may be any of a variety of shapes, such as a square cube, rectangular cube or pyramid. In some embodiments, the base 14 may be a square cube with rounded corners. The base 14 may be made of any of a variety of materials, such as a polymer or metal material, for example.

The first plug 18 of the device 20 may be used to receive a first network equipment device, such as a modem, for example. The second plug 16 may be used to receive a second network equipment device, such as a router, for example. The first plug 18 and second plug may be positioned in any of a variety of locations on the automated power cycling device 20, such as the top, bottom, front, side or rear. In some embodiments, the first plug 18 and second plug 16 are located on the front of the automated power cycling device 20. In some embodiments, the first plug 18 and second plug 16 are female adapters for 120 volts AC. The first plug 18 and second plug 16 may be made of any of a variety of materials, such as a polymer, rubber or metal material, for example.

In multiple embodiments, the device 20 also includes a timer (not shown) in communication with the first plug 18 and the second plug 16. This communication may be established via a wired or wireless connection as is known in the art. The timer may include a single timer or multiple timer units in communication with each other. Each timer may include one or more processors that include (or are communicatively coupled to) memory having computer executable storage instructions which, when executed by the processor(s), cause the timer(s) to perform their programmed function.

In multiple embodiments, the device 20 also includes four buttons: hours 24, clock 26, mins 28, and prog 30. These buttons, hours 24, clock 26, mins 28 and prog 30, may be used to program the current time and desired power cycle time for the network equipment that the device 20 powers. The buttons 24, 26, 28 and 30 may be positioned in any of a variety of locations on the automated power cycling device 20, such as the top, bottom, front, side or rear. In certain embodiments, the buttons 24, 26, 28 and 30 are located near the center of the front of the automated power cycling device 20. The buttons hours 24, clock 26, mins 28 and prog 30 may be made of any of a variety of materials, such as a polymer or rubber material, for example.

In some embodiments, the automated power cycling device 20 includes a display screen 10. The screen 10 may be used to display the current time and programmed time for reset. The screen 10 may be positioned in any of a variety of locations on the automated power cycling device 20, such as the top, bottom, front, side or rear. In certain embodiments, the display screen 10 is located near the top on the front of the automated power cycling device 20. The screen 10 may be made of any of a variety of display screen materials, such as liquid crystal display (LCD) materials.

Referring now to FIG. 2, a rear view for the automated power cycling device 20 is shown. The male adapter 22 may be positioned in any of a variety of locations on the automated power cycling device 20, such as the top, bottom, front, side or rear. In some embodiments, the male adapter 22 is located on the rear of the device 20. The male adapter 22 may be used for plugging into an input voltage source, such as a wall outlet, surge protector or UPS, for example. In multiple embodiments, the adapter 22 may be plugged into an input voltage source to give voltage to the device 20, and the network equipment will power through the first and second plugs 18, 16 (shown in FIG. 1) of the device 20. In some embodiments, the adapter 22 may be plugged into a 120 volt AC outlet plug to give voltage to the device 20. The adapter 22 may be made of any of a variety of materials, such as a polymer, rubber or metal material, for example.

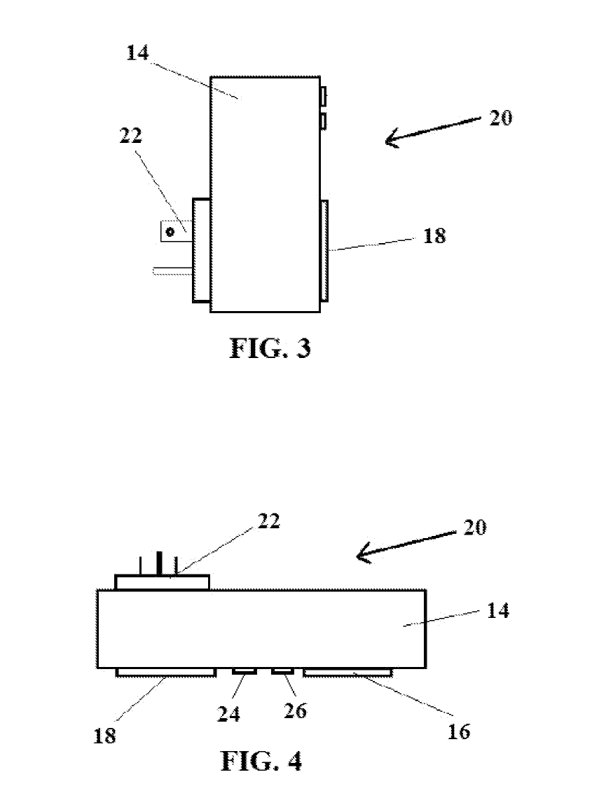

In FIG. 3, a side view of the automated power cycling device 20 is illustrated, showing the male adapter plug 22 and first plug 18. Turning to FIG. 4, a top view of the automated power cycling device 20 is shown. The male adapter plug 22, first plug 18 and second plug 16 are illustrated. In some embodiments, the programming buttons hours 24, clock 26, mins 28 (shown in FIG. 1) and prog 30 (shown in FIG. 1) protrude from the device 20.

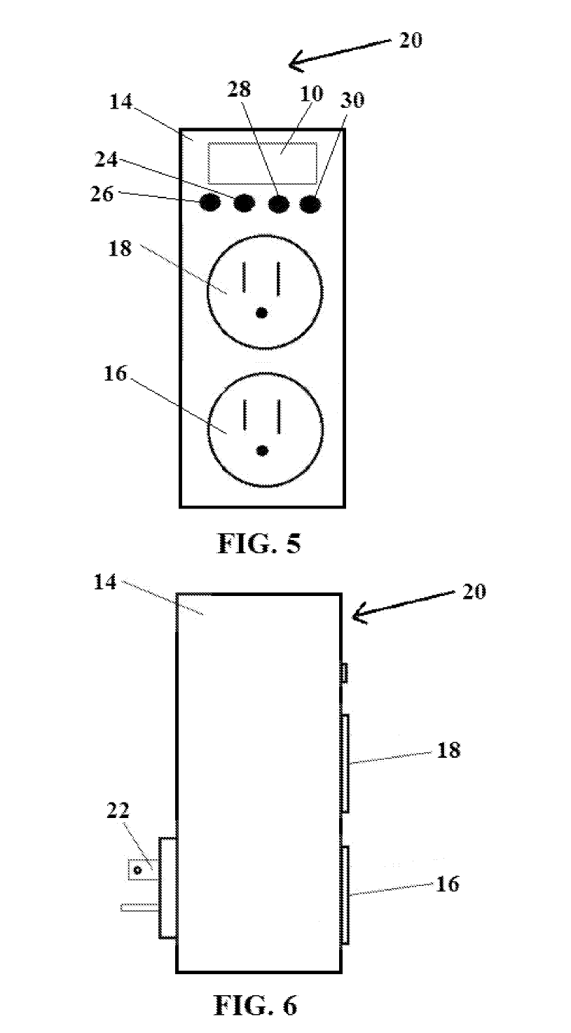

Turning now to FIGS. 5 and 6, another example embodiment of the automated power cycling device 20 with the base 14, first plug 18, second plug 16 and male adapter 22 is illustrated. As shown in FIGS. 5 and 6, the base 14 of the automated power cycling device 20 may be a rectangular cube. Referring to FIG. 5, the display screen 10 may be located near the top on the front of the automated power cycling device 20. The buttons hours 24, clock 26, mins 28 and prog 30 may be located below the screen 10, near the top on the front of the automated power cycling device 20.

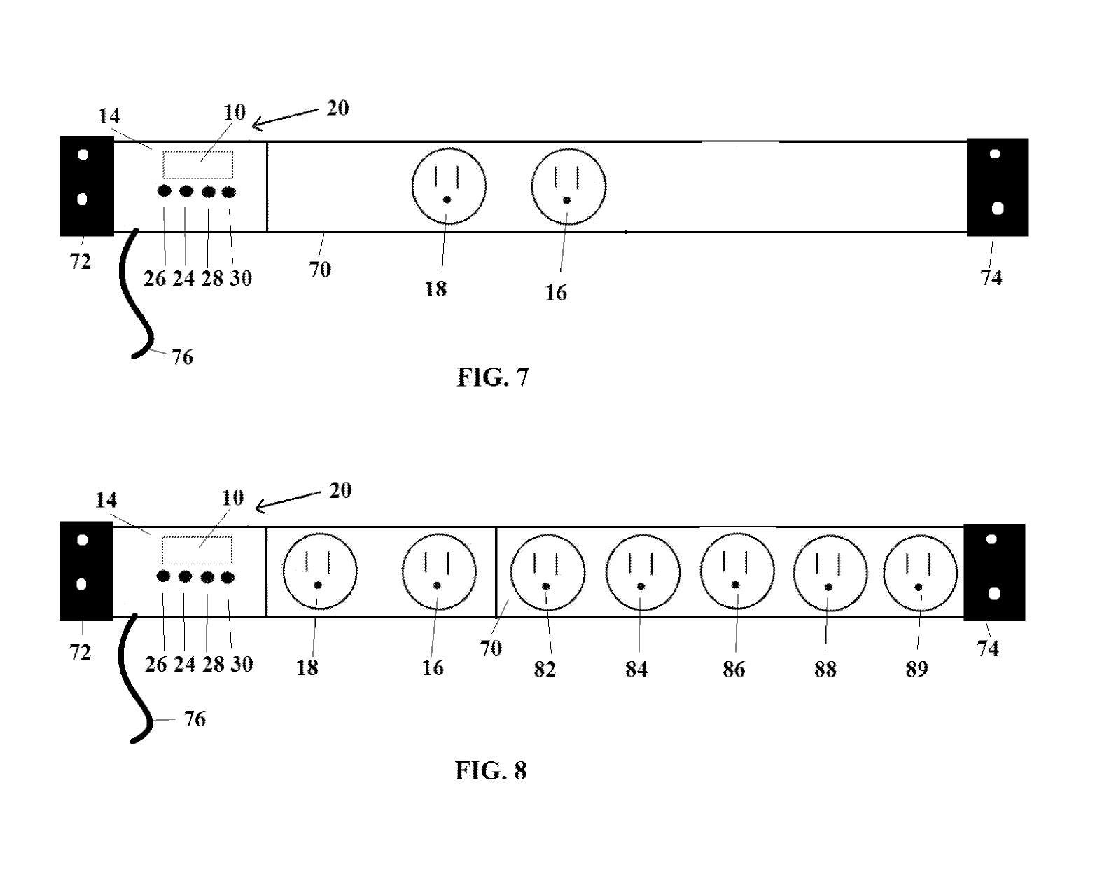

Turning to FIG. 7, an example embodiment of a power strip 70 with the automated power cycling device 20 is illustrated. As shown in FIG. 7, the device 20 may include the base 14, first plug 18 and second plug 16, and the power strip 70 may include mounts 72 and 74 and a power cord 76. The power strip 70 may also include a surge protector (not shown) to help protect the automated power cycling device 20 and devices connected to the power strip 70 from power surges.

The power strip 70 may be any of a variety of shapes, such as a rectangular cube or square cube, and may be made of any of a variety of materials, such as a polymer or metal material, for example.

The mounts 72 and 74 may be used to assist with mounting the power strip 70 on a wall, rack, counter or cabinet, for example. The mounts 72 and 74 may include apertures to assist with mounting the power strip 70 and may be positioned in any of a variety of locations on the power strip 70, such as the top, bottom, front, side or rear. In certain embodiments, the mounts 72 and 74 may be located on the sides of the power strip 70. The mounts 72 and 74 may be any of a variety of shapes, such as a rectangle or square, and may be made of any of a variety of materials, such as a metal material or polymer, for example. In some embodiments, the mounts 72 and 74 may be attached to the power strip, such as with screws or an adhesive, for example. In other embodiments, the mounts 72 and 74 may be integrally formed with the power strip 70.

The power cord 76 may be used for plugging into an input voltage source. The power cord 76 may include a male adapter (not shown) for plugging into an input voltage source, such as a wall outlet, surge protector or UPS, for example. In multiple embodiments, the power cord 76 may be plugged into an input voltage source to give voltage to the power strip 70 and the automated power cycling device 20, and the network equipment will power through the first and second plugs 18, 16 of the device 20. In some embodiments, the power cord 76 may be plugged into a 120 volt AC outlet plug to give voltage to the power strip 70 and the device 20.

Referring to FIG. 8, another example embodiment of the power strip 70 with the automated power cycling device 20 is shown. As illustrated in FIG. 8, the device 20 may include the base 14, first plug 18 and second plug 16, and the power strip 70 may include mounts 72 and 74, the power cord 76 and device plugs 82, 84, 86, 88 and 89. The power strip 70 may also include a surge protector (not shown) to help protect the automated power cycling device 20 and devices connected to the strip 70 from power surges.

The device plugs 82, 84, 86, 88 and 89 may be used to receive any of a variety of devices, such as computers, printers, scanners or speakers, for example. The device plugs 82, 84, 86, 88 and 89 may be positioned in any of a variety of locations on the power strip 70, such as the top, bottom, front, side or rear. In some embodiments, the device plugs 82, 84, 86, 88 and 89 are located on the front of the power strip 70. In some embodiments, the device plugs 82, 84, 86, 88 and 89 are female adapters for 120 volts AC. The device plugs 82, 84, 86, 88 and 89 may be made of any of a variety of materials, such as a polymer, rubber or metal material, for example.

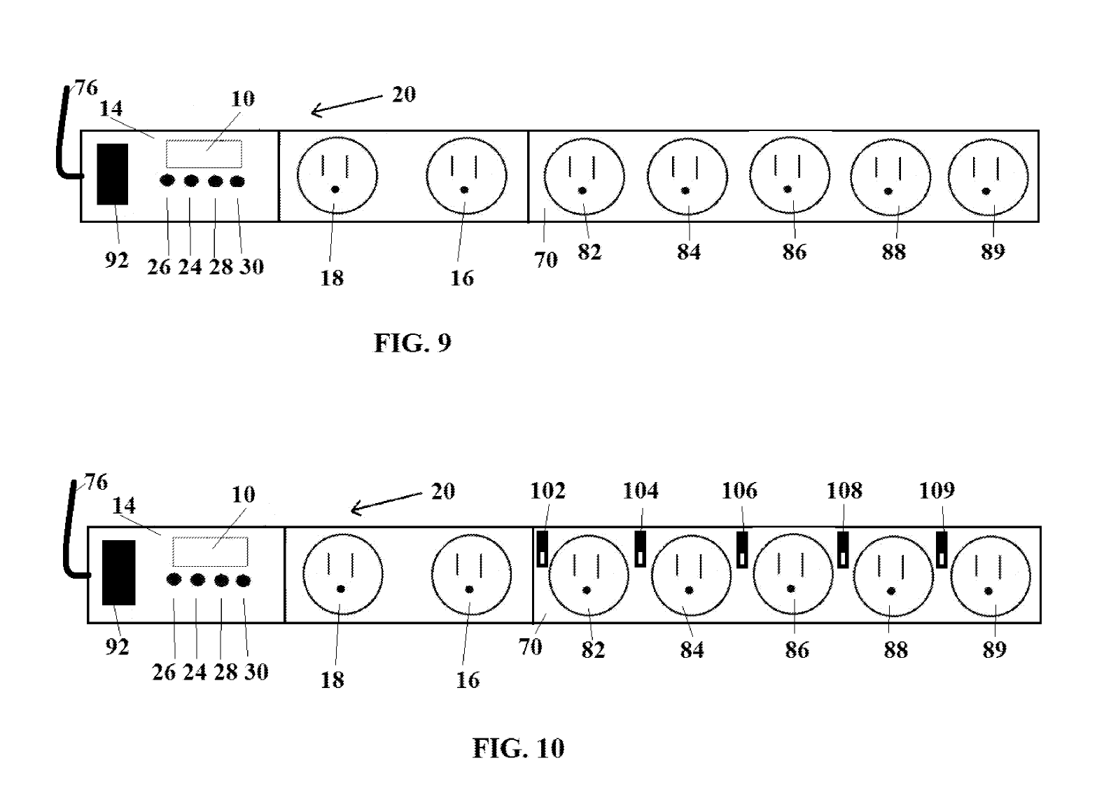

Turning to FIG. 9, another example embodiment of the power strip 70 with the automated power cycling device 20 is illustrated. As shown in FIG. 9, the power strip 70 may also include a main on and off switch 92.

Referring to FIG. 10, another example embodiment of the power strip 70 with the automated power cycling device 20 is shown. As illustrated in FIG. 10, the power strip 70 may also include device on and off switches 102, 104, 106, 108 and 109 corresponding to the device plugs 82, 84, 86, 88 and 89.

In use, in multiple embodiments, the automated power cycling device 20 will initiate power transmission to network equipment in sequential order. Such initiation of power transmission may occur at any of a variety of times, such as upon plugging the device 20 or the power strip 70 into an input voltage source, upon turning on the power strip 70 or upon the return of power to the device 20 after a power outage, for example. In such embodiments, the device 20 may keep power to the first plug 18 off for a first designated period of time, such as about one minute, for example. After the first designated period of time has passed, the device 20 then transmits power to the first plug 18 and allows the first plug 18 to transmit voltage to power the network equipment. The second plug 16 remains in the off state not transmitting voltage for a second designated period of time, such as from about 1 minute and 45 seconds to about one hour, for example. The device 20 transmits power to the second plug 16 and allows the second plug 16 to transmit voltage once the second designated period of time has passed and a delay has been established. The delay may range from about 45 seconds to about one hour, for example. Thus, the second plug 16 is reactive to the first plug 18 on the device 20.

Also, in multiple embodiments, the clock button 26 may be pressed and held down while the hours button 24 is pressed one time for every hour increase to adjust the device hour to the current hour. The clock button 26 may be pressed and held down while the mins button 28 is pressed one time for every minute increase to adjust the device minute to the current minute. After the current time is set on the device 20, a reset time may be programmed in the device. The prog button 30 may be pressed and held down while the hours button 24 is pressed one time for every hour increase to adjust the device hour to the desired hour to reset the network equipment that the device is powering. The prog button 30 may be pressed and held down while the mins button 28 is pressed one time for every minute increase to adjust the device minute to the desired minute to reset the network equipment that the device is powering. Thus, the device 20 may be programmed to automatically power cycle the network equipment at a convenient time, for example when individuals are not using the network.

In multiple embodiments, when the current time (programmed by the buttons hours 24, clock 26, mins 28 and prog 30) equals the programmed reset time (programmed by the buttons hours 24, clock 26, mins 28 and prog 30), the device 20 will perform an automated power cycle in sequential order. In such embodiments, at the beginning of the automated power cycle, the device 20 shuts off power to both the first plug 18 and the second plug 16, and the plugs stop transferring voltage to the network equipment. The device 20 keeps power to the first plug 18 off for a first designated period of time, such as about one minute, for example. After the first designated period of time has passed, the device 20 then restores power to the first plug 18 and allows the first plug 18 to transmit voltage to once again power the network equipment. The second plug 16 remains in the off state not transmitting voltage for a second designated period of time, such as from about 1 minute and 45 seconds to about one hour, for example. The device 20 restores power to the second plug 16 and allows the second plug 16 to transmit voltage once the second designated period of time has passed and a delay has been established. The delay may range from about 45 seconds to about one hour, for example. Thus, the second plug 16 is reactive to the first plug 18 on the device 20.

In some embodiments, the device 20 performs the automated power cycle regularly, each time a certain period of time has passed, such as twenty four hours, forty eight hours or seventy two hours, for example.

It will be appreciated that the reactive nature of the second plug 16 to the state of the first plug 18 in the automated power cycling device 20 provides significant benefits. Regularly automatically power cycling network equipment in sequential order, as compared to at the same time, significantly increases network efficiency and improves network connectivity. Further, the automated power cycling device 20 helps prevent individuals from having to manually power cycle network equipment when a network connection is lost. The device 20 automatically power cycles the network equipment at a convenient time, for example when individuals are not using the network.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. An automated power cycling device, comprising:
a base;
a first plug connected to the base, the first plug for receiving a first network equipment device;
a second plug connected to the base, the second plug for receiving a second network equipment device; and
an adapter connected to the base, the adapter for plugging into an input voltage source,
wherein the automated power cycling device is configured to initiate power transmission to the first network equipment device and the second network equipment device in sequential order.

2. The automated power cycling device of claim 1, wherein the automated power cycling device is configured to automatically shut off power to the first and second network equipment devices and then restore power to the first network equipment device and the second network equipment device in sequential order.

3. The automated power cycling device of claim 2, wherein the automated power cycling device is configured to keep power to the first network equipment device off for about one minute.

4. The automated power cycling device of claim 2, wherein the automated power cycling device is configured to keep power to the second network equipment device off from about 1 minute and 45 seconds to about one hour.

5. The automated power cycling device of claim 2, wherein the automated power cycling device is configured to automatically shut off power to the first and second network equipment devices at a reset time.

6. The automated power cycling device of claim 1, wherein the first network equipment device comprises a modem.

7. The automated power cycling device of claim 1, wherein the second network equipment device comprises a router.

8. A automated power cycling device, comprising:
a base;
a first plug connected to the base, the first plug for receiving a first network equipment device;
a second plug connected to the base, the second plug for receiving a second network equipment device; and
an adapter connected to the base, the adapter for plugging into an input voltage source,
wherein the automated power cycling device automatically shuts off power to the first and second network equipment devices and then restores power to the first network equipment device and the second network equipment device in sequential order.

9. The automated power cycling device of claim 8, wherein the automated power cycling device keeps power to the first network equipment device off for about one minute.

10. The automated power cycling device of claim 8, wherein the automated power cycling device keeps power to the second network equipment device off from about 1 minute and 45 seconds to about one hour.

11. The automated power cycling device of claim 8, wherein the automated power cycling device automatically shuts off power to the first and second network equipment devices at a reset time.

12. The automated power cycling device of claim 8, wherein the first network equipment device comprises a modem.

13. The automated power cycling device of claim 8, wherein the second network equipment device comprises a router.

14. A power strip device, comprising:
an automated power cycling device having a base, a first plug connected to the base and a second plug connected to the base; and
a power cord,
wherein the first plug is for receiving a first network equipment device, the second plug is for receiving a second network equipment device and the power cord is for plugging into an input voltage source and wherein the automated power cycling device is configured to initiate power transmission to the first network equipment device and the second network equipment device in sequential order.

15. The power strip device of claim 14, wherein the automated power cycling device is configured to automatically shut off power to the first and second network equipment devices and then restore power to the first network equipment device and the second network equipment device in sequential order.

16. The power strip device of claim 15, wherein the automated power cycling device is configured to keep power to the first network equipment device off for about one minute.

17. The power strip device of claim 15, wherein the automated power cycling device is configured to keep power to the second network equipment device off from about 1 minute and 45 seconds to about one hour.

18. The power strip device of claim 15, wherein the automated power cycling device is configured to automatically shut off power to the first and second network equipment devices at a reset time.

19. The power strip device of claim 14, further comprising a surge protector.

20. The power strip device of claim 14, further comprising a mount for mounting the power strip.
